(19) United States
(12) Patent Application Publication
(10) Pub. No.: US 2019/0118780 A1
(43) Pub. Date: Apr. 25, 2019

(54) AIR DISCHARGE DEVICE

(71) Applicant: DENSO CORPORATION, Kariya-city (JP)

(72) Inventor: Hirohisa MOTOMURA, Kariya-city (JP)

(21) Appl. No.: 16/224,239

(22) Filed: Dec. 18, 2018

Related U.S. Application Data
(63) Continuation of application No. PCT/JP2017/016832, filed on Apr. 27, 2017.

(30) Foreign Application Priority Data
Jun. 20, 2016 (JP) 2016-121957

(51) Int. Cl. B60S 1/54; B60S 1/02; B60H 1/34; F24F 13/08

(52) U.S. Cl. CPC B60S 1/54; F24F 13/08; B60H 1/3414; B60S 1/023

(57) ABSTRACT

A blowout portion of an air discharge device includes a blowout port and a blowout passage that guides air toward the blowout port. Further, an air flow manipulation member of the air discharge device is disposed in the blowout passage and includes a guide wall. The air flow manipulation member switches between a first operation state that throttles an air flow flowing in one side passage which is part of the blowout passage to cause the air flow to flow along a passage guide surface of the blowout portion, and a second operation state that reduces the throttling of that air flow. The guide wall is arranged to regulate air flow when the air flow manipulation member is in the second operation state, and to substantially not regulate air flow when the air flow manipulation member is in the first operation state.

### CROSS REFERENCE TO RELATED APPLICATIONS

The present application is a continuation application of International Patent Application No. PCT/JP2017/016832 filed on Apr. 27, 2017, which designated the United States and claims the benefit of priority from Japanese Patent Application No. 2016-121957 filed on Jun. 20, 2016. The entire disclosures of all of the above applications are incorporated herein by reference.

### TECHNICAL FIELD

The present disclosure relates to an air discharge device that discharges air.

### BACKGROUND

Air discharge devices are commonly included in vehicular air conditioning systems. Such an air discharge device may be configured to regulate the flow direction of blowout air along two different directions.

### SUMMARY

In one exemplary aspect of the present disclosure, an air discharge device may include a blowout portion having a passage guide surface, the blowout portion forming a blowout port that opens toward one side in a first direction along an axis line and a blowout passage connected to the blowout port that guides air toward the blowout port, the blowout port being configured to blow out air into the passenger compartment, and an air flow manipulation member disposed in the blowout passage, the air flow manipulation member including a guide wall and a main body portion. In this exemplary aspect, the passage guide surface is positioned on one side of the blowout passage in a second direction that intersects the first direction to face the blowout passage, the passage guide surface extending from the one side in the first direction toward an other side opposite to the one side in the first direction while bending toward the one side in the second direction, the air flow manipulation member forms one side passage as a part of the blowout passage, the one side passage being positioned toward the one side in the second direction with respect to the main body portion, and switches between a first operation state that throttles an air flow flowing in the one side passage with the main body portion as compared to the air prior to entering the one side passage to cause the air flow to flow along the passage guide surface, and a second operation state that reduces the throttling of the air flow flowing in the one side passage as compared with the first operation state, and the guide wall is arranged so as to, when the air flow manipulation member is in the first operation state, protrude from the main body portion toward the one side in the first direction, and when the air flow manipulation member is in the second operation state, guides air toward the blowout port while regulating a direction of the flow of the guided air along a third direction that intersects the first direction and the second direction.

### BRIEF DESCRIPTION OF DRAWINGS

FIG. 1 is a schematic view of a vehicular front portion of a vehicle compartment viewed from a vehicular upper side.

FIG. 2 is a cross-sectional view of cross section II-II in FIG. 1 showing an air discharge device during a face mode.

FIG. 3 is a perspective view showing an air flow deflection door as a single body.

FIG. 4 is a cross-sectional view of cross section II-II in FIG. 1 showing an air discharge device during a defroster mode.

FIG. 5 is a partial cross-sectional view showing a portion of cross section V-V in FIG. 3.

FIG. 6 is a plane view showing a guide base surface side of an air flow deflection door only.

FIG. 7 is a schematic view of a vehicular front portion of a vehicle compartment viewed from a vehicular upper side, in a comparative example, and corresponds to FIG. 1.

FIG. 8 is a cross-sectional view showing an air discharge device during a face mode, and corresponds to FIG. 2.

FIG. 9 is a cross-sectional view showing an air discharge device during a defroster mode, and corresponds to FIG. 4.

FIG. 10 is a plane view showing a guide base surface side of an air flow deflection door only, corresponding to FIG. 6.

FIG. 11 is a plane view showing a guide base surface side of an air flow deflection door only, corresponding to FIG. 6.

FIG. 12 is a plane view showing a guide base surface side of an air flow deflection door only, corresponding to FIG. 6.

FIG. 13 is a plane view showing a guide base surface side of an air flow deflection door only, corresponding to FIG. 6.

### DESCRIPTION OF EMBODIMENTS

Hereinafter, embodiments of the present disclosure will be described with reference to the drawings. In the following embodiments, identical or equivalent elements are denoted by the same reference numerals as each other in the figures.

### First Embodiment

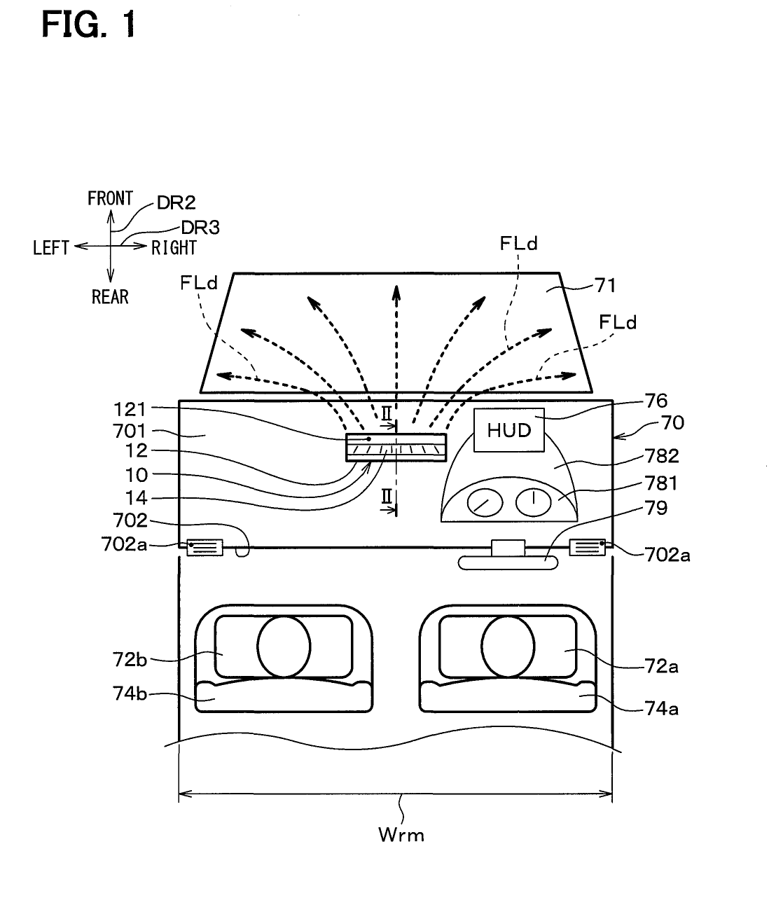

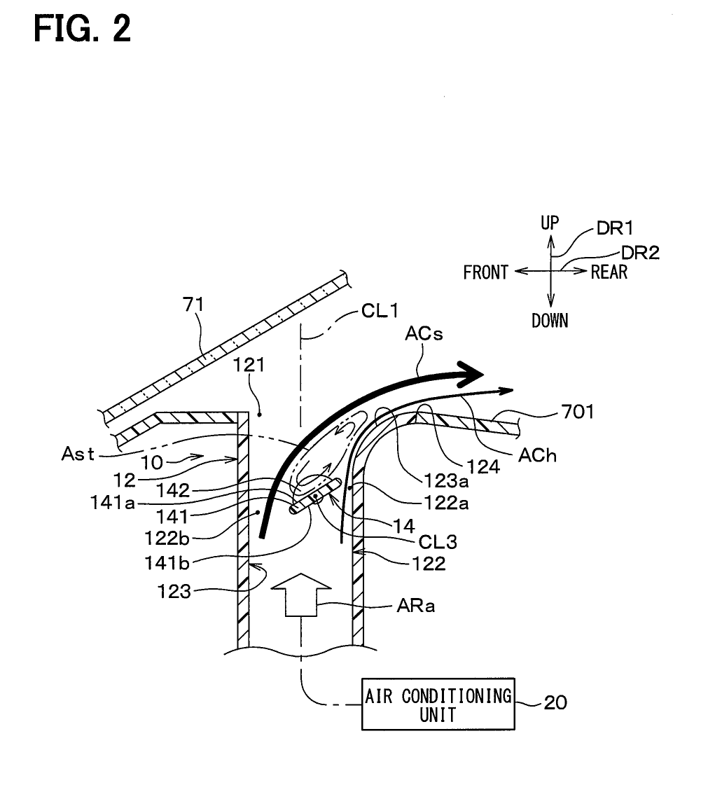

As shown in FIGS. 1 and 2, an air discharge device 10 of the present embodiment is applied to a blowout port and a duct of an air conditioning unit 20 arranged on a vehicle front side. An arrow DR1 in FIG. 2 indicates a vehicle up-down direction DR1 as a first direction, i.e., a vehicle vertical direction DR1.

An arrow DR2 indicates a vehicle front-rear direction DR2 as a second direction. Further, an arrow DR3 in FIG. 1 indicates a vehicle left-right direction DR3 as a third direction, i.e., a vehicle width direction DR3. These three directions DR1, DR2, DR3 are directions which intersect each other. More strictly speaking, these directions are orthogonal to one another.

Further, in the present embodiment, a vehicle upper side corresponds to one side in the first direction, a vehicle lower side corresponds to the other side in the first direction, a vehicle rear side corresponds to one side in the second direction, and a vehicle front side corresponds to the other side in the second direction. Further, in the present embodiment, one side of the vehicle width direction DR3 corresponds to a vehicle right side, and the other side of the vehicle width direction DR3 corresponds to a vehicle left side.

The air conditioning unit 20 in the present embodiment is a well-known device arranged in an instrument panel 70, and blows out temperature adjusted air conditioning air toward the vehicle compartment. For example, the air conditioning unit 20 may be the same as the air conditioning unit shown in FIG. 2 of Patent Document 1. In addition, the air conditioning unit 20 functions as a blowing device with respect to the air discharge device 10, which sends air to the air discharge device 10.

As shown in FIGS. 1 and 2, similarly to a typical vehicle, the instrument panel 70 is disposed in the vehicle front side in the passenger compartment. Further, a driver seat 74a corresponding to a first seat and a passenger seat 74b corresponding to a second seat are housed in the passenger compartment. These two seats 74a and 74b are the front seats in the passenger compartment, and are arranged on the vehicle rear side relative to the instrument panel 70. Further, these two seats 74a and 74b are arranged side by side along the vehicle width direction DR3. The driver seat 74a is disposed on the right side facing the front side of the vehicle. Further, the passenger seat 74b is disposed on the left side facing the vehicle front side. Passengers 72a and 72b are seated on the seats 74a and 74b, respectively.

Further, a HUD 76, a meter panel 781, and a meter hood 782 covering the meter panel 781 are disposed in the instrument panel 70 in front of the driver seat 74a (i.e., on the vehicle front side with respect to the driver seat 74a). The meter panel 781 is a meter panel including a speed meter, a tachometer, and the like. Further, the steering wheel 79 is arranged in front of the driver seat 74a so as to protrude from the instrument panel 70 toward the driver seat 74a. Note that HUD described above is an abbreviation for “Head Up Display”.

Two side face blowout ports 702a are provided in a front surface portion 702 of the instrument panel 70. The front surface portion 702 faces toward the vehicle rear side, i.e., toward the seats 74a, 74b. The side face blowout ports 702a are disposed at both end portions of the front surface portion 702 along the vehicle width direction DR3, and blows out air from the air conditioning unit 20.

As shown in FIGS. 1 and 2, the air discharge device 10 is a device that blows air from the air conditioning unit 20 into a passenger compartment and adjusts the blowing direction of that air. Here, the passenger compartment corresponds to an air conditioning target space. The air discharge device 10 is provided with a blowout portion 12 which blows out the air flowing from the air conditioning unit 20 into the passenger compartment, and an air flow deflection door 14 which corresponds to an air flow operation member.

A blowout port 121 which blows out air from the air conditioning unit 20 into the passenger compartment and a blowout passage 122 are formed in the blowout portion 12. The blowout passage 122 is connected to the blowout port 121. In other words, the blowout port 121 is also a downstream side edge of the blowout passage 122 in the blowout air flow direction. This blowout air flow direction is the flow direction of the main flow of the blowout air blown out from the blowout port 121. This blowout air flow direction is an upward direction on the upstream side of the air flow deflection door 14 in the blowout passage 122, for example shown as arrow ARa in FIG. 2. Further, on the downstream side of the air flow deflection door 14, the blowout air flow direction is changed by the air flow deflection door 14.

The blowout port 121 opens facing upward along the vehicle up-down direction DR1. In other words, at least the downstream end portion of the blowout passage 122 on the blowout air flow downstream side is a passage that faces along the vehicle up-down direction DR1. The blowout port 121 has a rectangular shape with the vehicle width direction DR3 as the longitudinal direction. Further, the blowout air flow downstream side described above is the downstream side in the blowout air flow direction. Conversely, the upstream side of the blowout air flow direction is referred to as a blowout air flow upstream side.

Further, the blowout port 121 is provided on an upper surface 701 of the instrument panel 70 provided in the passenger compartment, and is provided toward the front of the vehicle. Accordingly, the blowout port 121 is disposed on the front side in the vehicle front-rear direction DR2 with respect to the driver seat 74a and the passenger seat 74b disposed in the passenger compartment. In addition, the blowout port 121 is disposed the vehicle lower side with respect to the front window 71 of the vehicle, which is inclined so as to be positioned closer toward the rear side of the vehicle the further toward the upper side of the vehicle.

Further, the blowout port 121 is provided in a central portion of the upper surface 701 of the instrument panel 70 in a width Wrm of the passenger compartment along the vehicle width direction DR3. In addition, the blowout portion 12 which forms the blowout port 121 constitutes a part of the instrument panel 70, that is, a portion around the blowout port 121.

Further, since the instrument panel 70 is provided with the HUD 76 and the meter hood 782, the width of the blowout port 121 in the vehicle width direction DR3 is restricted by the HUD 76 and the meter hood 782. For example, the blowout port 121 is provided close to the HUD 76 and the meter hood 782 along the vehicle width direction DR3.

The blowout passage 122 guides air from the air conditioning unit 20 to the blowout port 121. An air passage cross section of the blowout passage 122 orthogonal to the direction of the air flow in the blowout passage 122 has a rectangular shape whose longitudinal direction is the vehicle width direction DR3, similar to the blowout port 121. Further, since the blowout passage 122 is connected to the upward-facing blowout port 121, a center axis CL1 of the blowout passage 122, which is one axis line, is oriented along the vehicle up-down direction DR1.

Further, the blowout portion 12 includes a passage inner wall surface 123 which faces the blowout passage 122. That is, the blowout passage 122 is formed by being surrounded by the passage inner wall surface 123.

The blowout portion 12 includes a portion of its inner wall surface 123 as a passage guide surface 123a which guides the air blown out from the blowout port 121. The passage guide surface 123a is a portion that extends from a peripheral portion 124 of the blowout port 121 toward the blowout air flow upstream side.

Further, more specifically, the passage guide surface 123a is located on one side (specifically, the rear side) of the blowout passage 122 in the vehicle front-rear direction DR2 and faces the blowout passage 122. The passage guide surface 123a extends from the vehicle lower side to the vehicle upper side while bending toward the rear side of the vehicle.

Further, when looking at the relationship between the blowout passage 122 and the passage guide surface 123a, the passage guide surface 123a is shaped such that, the closer toward the blowout air flow downstream side, the upward facing blowout passage 122 is enlarged toward the vehicle rear side. More specifically, the passage guide surface 123a is formed by a curved surface warped such that the side of the passage guide surface 123a facing the blowout passage 122 is a convex side which, the further toward the vehicle upper side, is positioned toward the vehicle rear side.

In addition, the passage guide surface 123a is formed so as to connect to the upper surface 701 of the instrument panel 70 in a continuous manner. This passage guide surface 123a guides a high-speed air flow ACh flowing out of a rear side passage 122a included in the blowout passage 122 along the passage guide surface 123a toward the rear side of the vehicle front-rear direction DR2.

Since the blowout portion 12 includes the passage guide surface 123a in this manner, when the blowout air blown out from the blowout port 121 flows along the passage guide surface 123a, the blowout air is blown toward the passengers 72a, 72b seated in the driver seat 74a or the passenger seat 74b. On the other hand, when that blowout air does not flow along the passage guide surface 123a, that blowout air is blown toward the vehicle upper side, i.e., the opening direction of the blowout port 121. That is, in this case, the blowout air is blown as indicated by the arrows FLd toward the front window 71 provided on the vehicle upper side with respect to the blowout port 121.

As shown in FIGS. 1 and 2, the air flow deflection door 14 is disposed in the blowout passage 122. The operation of the air flow deflection door 14 is controlled by a control signal outputted from a control device (not illustrated).

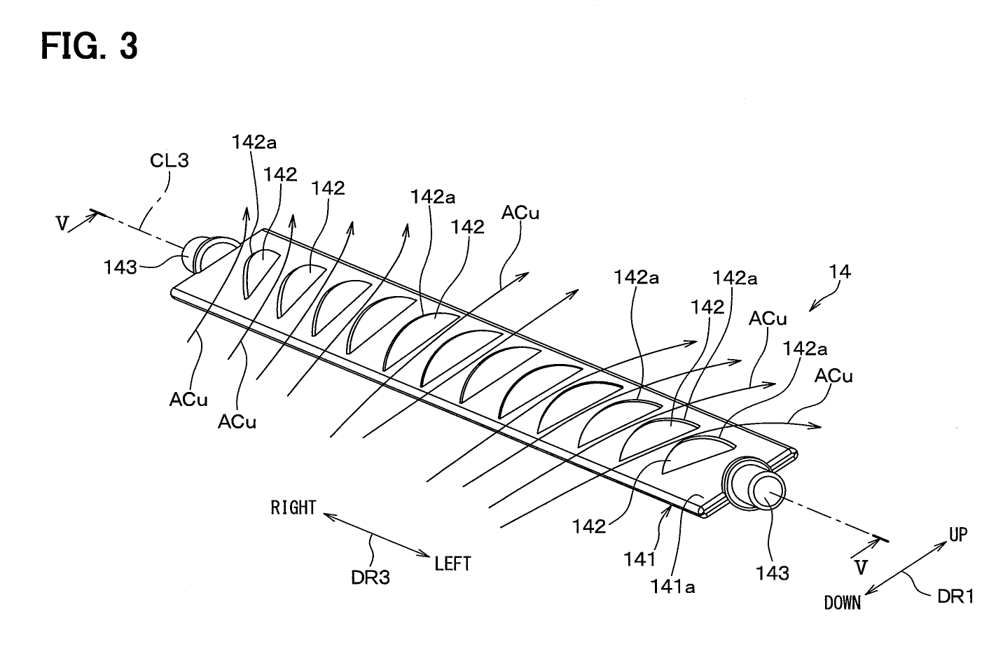

As shown in FIGS. 2 and 3, the air flow deflection door 14 is a plate-shaped rotating member that rotates about a rotation axis line CL3 along the vehicle width direction DR3. That is, the air flow deflection door 14 is a pivotal type flap. Specifically, the air flow deflection door 14 includes a plate door portion 141 that serves as a main body portion of the air flow deflection door 14, a plurality of guide walls 142, and a door rotating shaft 143. The plate door portion 141, the guide walls 142, and the door rotating shaft 143 are integrally molded to form the air flow deflection door 14.

The door rotating shaft 143 protrudes outwards in the vehicle width direction DR3 from both ends of the plate door portion 141 in the vehicle width direction DR3, and is fitted into fitting holes (not illustrated) formed in the passage inner wall surface 123 of the blowout portion 12. Due to this, the air flow deflection door 14 is supported so as to be rotatable with respect to the blowout portion 12 about the rotation axis line CL3.

The plate door portion 141 of the air flow deflection door 14 has a length extending over the entire width of the blowout path 122 in the vehicle width direction DR3, for example as shown in FIG. 1. Therefore, the plate door portion 141 is arranged such that its longitudinal direction is the vehicle width direction DR3. The plate door portion 141 may, for example, have a rectangular flat plate shape.

As shown in FIGS. 1 and 2, since the air flow deflection door 14 is disposed in the blowout passage 122, two parallel air passages 122a, 122b are formed as a part of the blowout passage 122. More specifically, the air flow deflection door 14 forms a rear side passage 122a (that is, one side passage 122a) as part of the blowout passage 122. The rear side passage 122a is a first passage positioned on the rear side, i.e., on one side, of the plate door portion 141 in the vehicle front-rear direction DR2. At the same time, the air flow deflection door 14 forms a front side passage 122b (that is, an other side passage 122b) as part of the blowout passage 122. The front side passage 122b is a second passage positioned on the front side, i.e., on the other side, of the plate door portion 141 in the vehicle front-rear direction DR2.

Further, the air flow deflection door 14 increases and decreases each of the passage cross-sectional area of the rear side passage 122a and the passage cross-sectional area of the front side passage 122b according to a rotation angle about the rotation axis CL3. For example, the air flow deflection door 14 increases or decreases the passage cross-sectional area of the rear side passage 122a due to a change in the rotation angle of the air flow deflection door 14. The air flow deflection door 14 also increases or decreases the air flow velocity of the rear side passage 122a by changing the cross-sectional area of the rear side passage 122a according to the rotation of the air flow deflection door 14.

Here, the described above passage cross-sectional area of the rear side passage 122a which is increased or decreased by the air flow deflection door 14 refers to the passage cross-sectional area at a narrow-most position in the rear side passage 122a due to the air flow deflection door 14. In addition, since the blowout passage 122 extends along the vehicle up-down direction DR1, the passage cross-sectional area of the rear side passage 122a is the area of a cross-section of the rear side passage 122a normal to the vehicle up-down direction. These points also apply to the passage cross-sectional area of the front side passage 122b.

Here, the blowout mode of the air discharge device 10 is selectively switched between a face mode and a defroster mode. For example, the blowout mode of the air discharge device 10 may be switched to be the same as the blowout mode of the air conditioning unit 20. The face mode is a blowout mode in which air is blown toward the upper bodies of the front seat passengers 72a, 72b. Further, the defroster mode is a blowout mode in which air is blown toward the front window 71 which is the windshield, and fogging of the windshield is cleared. Further, as another mode other than the face mode and the defroster mode, the blowout mode of the air conditioning unit 20 may be switched to a foot mode in which air is blown to the feet of the occupants. In this foot mode, for example, the air passage from the air conditioning unit 20 to the air discharge device 10 may be closed, so that the air conditioning unit 20 blows air from a foot air outlet of the air conditioning unit 20.

The air flow deflection door 14 is set to a predetermined first operation state when the blowout mode of the air discharge device 10 is the face mode, and is set to a predetermined second operation state when the blowout mode of the air discharge device 10 is the defroster mode. In short, the air flow deflection door 14 is selectively switched between the first operation state and the second operation state according to the blowout mode of the air discharge device 10 by rotating about the rotation axis CL3.

Specifically, as shown in FIG. 2, when the air flow deflection door 14 enters the first operation state, the flow of the air flowing through the rear side passage 122a is throttled by the plate door portion 141 as compared to the air prior to flowing into the rear side passage 122a. Accordingly, the flow of the air is made to follow the passage guide surface 123a.

That is, when the air flow deflection door 14 enters the first operation state, the passage cross-sectional area of the rear side passage 122a is reduced to below an area threshold value by the air flow deflection door 14. This area threshold value is experimentally determined in advance. As a result, a jet flow is formed in the rear side passage 122a as a high speed air flow ACh to be blown into the passenger compartment along the passage guide surface 123a due to the Coanda effect. At the same time, a low speed air flow ACs lower than the high speed air flow ACh is formed in the front side passage 122b.

That is, when the air flow deflection door 14 is set in the first operation state, due to the Coanda effect which occurs according to the air flow speed of the air flowing through the rear side passage 122a, the flow of air flowing in the rear side passage 122a (that is, the high speed air flow ACh) is made to follow along the passage guide surface 123a. At the same time, the low speed air flow ACs in the front side passage 122b is drawn toward the high speed air flow ACh in the rear side passage 122a by the Coanda effect, and flows toward the vehicle rear side. Therefore, due to the air flow in the rear side passage 122a following the passage guide surface 123a in this manner, the blowout air blown out from the blowout port 121 bends toward the rear side in the vehicle front-rear direction DR2 and flows out.

Further, when the air flow deflection door 14 is in the first operation state, since the rear side passage 122a is throttled by the plate door portion 141, the air flow rate in the front side passage 122b is higher than the air flow rate in the rear side passage 122a.

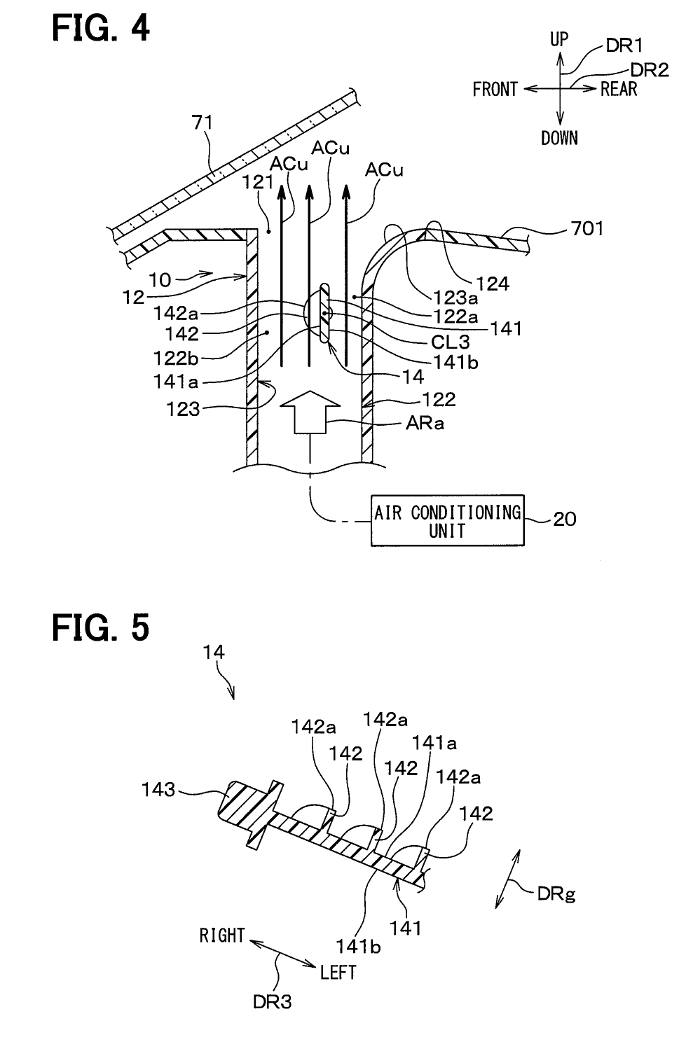

On the other hand, when the air flow deflection door 14 enters the second operation state, as shown in FIG. 4, air flows different from the case when the air flow deflection door 14 is in the first operation state are formed in the blowout passage 122. Specifically, when the air flow deflection door 14 is set in the second operation state, the passage cross-sectional area of the rear side passage 122a is greater as compared with the case of the first operation state. That is, the air flow deflection door 14 reduces the throttling of the flow of air flowing through the rear side passage 122a as compared with the case when the air flow deflection door 14 is in the first operation state.

As a result, when the air flow deflection door 14 is set in the second operation state, the flow velocity of the air flow formed in the rear side passage 122a is lower than in the case of the first operation state. Further, the air flow in the rear side passage 122a substantially does not follow the passage guide surface 123a, and the blowout air blown out from the blowout port 121 flows upward along the center axis CL1 (see FIG. 2) of the blowout passage 122 as indicated by the arrows ACu.

When the air flow deflection door 14 is set to the second operation state, the air flow deflection door 14 assumes an orientation in which the thickness direction of the air flow deflection door 14 is set to the vehicle front-rear direction DR2. Further, the rotational axis line CL3 of the air flow deflection door 14 is positioned so as to be offset toward the rear side in the vehicle front-rear direction DR2 with respect to the center position of the blowout passage 122. Therefore, when the air flow deflection door 14 is in the second operation state, the passage cross-sectional area of the front side passage 122b is greater than the passage cross-sectional area of the rear side passage 122a. Therefore, when the air flow deflection door 14 is in the second operation state as well, the air flow rate in the front side passage 122b is greater than the air flow rate in the rear side passage 122a.

Further, as long as the air flow deflection door 14 is able to deflect air flow velocity between the rear side passage 122a and the front side passage 122b, it is not necessary for the air flow deflection door 14 to be formed so as to completely separate the rear side passage 122a and the front side passage 122b.

As shown in FIGS. 3 and 5, since the plate door portion 141 of the air flow deflection door 14 has a flat plate shape, the plate door portion 141 includes a guide base surface 141a and a guide opposite surface 141b. The guide base surface is one surface provided on one side in the thickness direction of the plate door portion 141. The guide opposite surface 141b is an other surface provided on the other side in the thickness direction of the plate door portion 141.

Further, the plurality of guide walls 142 protrude from the guide base surface 141a along a normal direction DRg to the guide base surface 141a. The guide walls 142 each have a plate shape, that is, a rib shape. In addition, each of the guide walls 142 has an end edge 142a that protrudes from the plate door portion 141, the end edges 142a being curved in a convex shape. For example, the end edges 142a may have an arc shape.

The facing direction of the guide base surface 141a of the air flow deflection door 14 changes according to the rotation operation of the air flow deflection door 14. That is, when the air flow deflection door 14 is in the first operation state, the guide base surface 141a faces more toward the vehicle upper side than when the air flow deflection door 14 is in the second operation state. Further, when the air flow deflection door 14 is in the second operation state, the guide base surface 141a faces more toward the vehicle front side than when the air flow deflection door 14 is in the first operation state.

Specifically, as shown in FIGS. 2 and 3, when the air flow deflection door 14 is in the first operation state, the guide base surface 141a of the plate door portion 141 faces more toward the vehicle upper side than the guide base surface 141a faces toward the vehicle front side or the vehicle rear side. In this example, the guide base surface 141a faces obliquely toward the vehicle upper side. Therefore, when the air flow deflection door 14 is in the first operation state, the plurality of guide walls 142 are disposed so as to protrude from the plate door portion 141 toward the vehicle upper side.

Here, when the air flow deflection door 14 is in the first operation state, as shown in FIG. 2, a stagnation zone Ast is formed on the blowout air flow downstream side of the plate door portion 141. In particular, the stagnation zone Ast is surrounded by the high speed air flow ACh and the low speed air flow ACs. In this stagnation zone Ast, air stagnates due to the air flow being blocked by the air flow deflection door 14. When the air flow deflection door 14 is in the first operation state, the stagnation zone Ast always exists.

Therefore, when the air flow deflection door 14 is in the first operation state, the plurality of guide walls 142 are positioned so as not to protrude out of the stagnation zone Ast. Accordingly, the guide walls tend to not interfere with either of the air flows ACh, ACs flowing toward the blowout port 121.

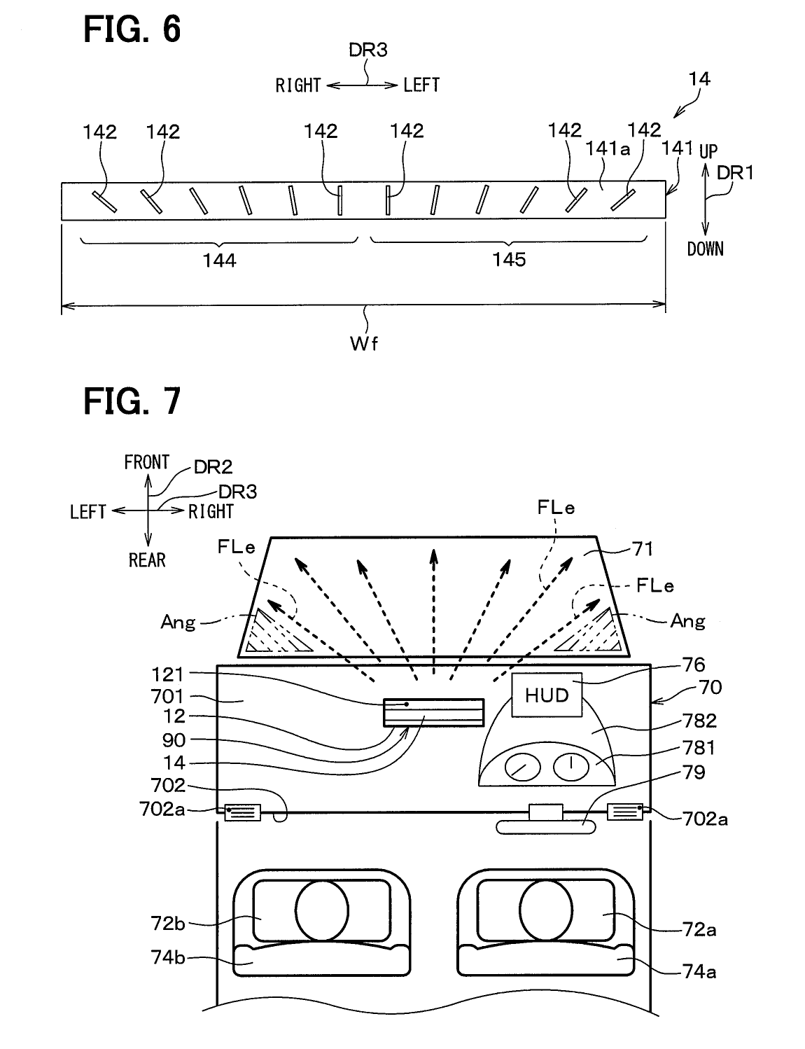

Conversely, as shown in FIGS. 3 and 4, when the air flow deflection door 14 is in the second operation state, the guide base surface 141a of the plate door portion 141 faces toward the vehicle front side. Therefore, when the air flow deflection door 14 is in the second operation state, the plurality of guide walls 142 are disposed so as to protrude from the plate door portion 141 toward the vehicle front side. That is, the plurality of guide walls 142 are disposed so as to protrude from the plate door portion 141 toward the front side passage 122b. With such an arrangement, the plurality of guide walls 142 guide the air toward the blowout port 121 as indicated by the arrows ACu in FIG. 3, and regulate the direction of the guided air flow along the vehicle width direction DR3. Here, the arrow DR1 in FIG. 3 indicates the vehicle up-down direction DR1 when the air flow deflection door 14 is in the second operation state. The same applies to FIGS. 6 and 10 to 13 described later.

In the present embodiment, as an example and shown in FIGS. 3 and 6, the plurality of guide walls 142 may be arranged side by side along the vehicle width direction DR3 a spacing between mutual ones of the guide walls 142. Further, the plurality of guide walls 142 are arranged symmetrically along the vehicle width direction DR3. For this reason, the entire group of guide walls 142 of the air flow deflection door 14 can be recognized as two separate guide wall groups 144, 145.

In other words, the entire group of guide walls 142 of the air flow deflection door 14 are divided into a plurality of guide walls 142 forming one side guide wall group 144 and a plurality of guide walls 142 forming an other side guide wall group 145. When divided in this manner, among all the guide walls 142 included in the air flow deflection door 14, the plurality of guide walls 142 arranged on one side in the vehicle width direction DR3 (that is, on the right side of the vehicle), with the central portion of the plate door portion 141 as the boundary, constitute the one side guide wall group 144. Further, among all the guide walls 142 included in the air flow deflection door 14, the plurality of guide walls 142 arranged on the other side in the vehicle width direction DR3 (that is, on the left side of the vehicle), with the central portion of the plate door portion 141 as the boundary, constitute the other side guide wall group 145.

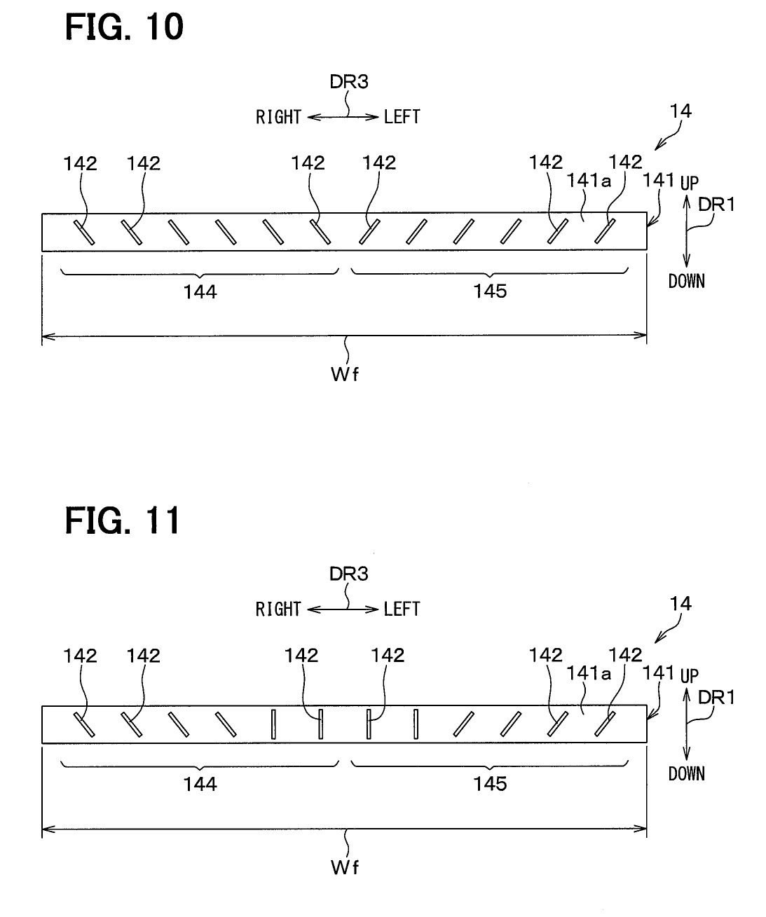

When the one side guide wall group 144 and the other side guide wall group 145 are arranged in this manner, the one side guide wall group 144 is arranged on one side in the vehicle width direction DR3 with respect to the other side guide wall group 145. In FIG. 6, the illustration of the door rotating shaft 143 is omitted, and this also applies to FIGS. 10 to 13 described later.

As shown in FIGS. 3, 4, and 6, when the air flow deflection door 14 is in the second operation state, any one of the plurality of guide walls 142 constituting the one side guide wall group 144 is inclined with respect to the central axis line CL1 of the blowout passage 122 so as to be closer to the one side in the vehicle width direction DR3 the further toward the vehicle upper side. Specifically, when the air flow deflection door 14 is in the second operation state, among the plurality of guide walls 142 of the one side guide wall group 144, the closer a particular guide wall 142 is arranged toward the one side in the vehicle width direction DR3, the more the vehicle upper side of that guide wall 142 is inclined toward the one side in the vehicle width direction DR3 with respect to the central axis CL1 of the blowout passage 122.

Further, the other side guide wall group 145 is symmetrical with the one side guide wall group 144 in the vehicle width direction DR3. In other words, when the air flow deflection door 14 is in the second operation state, any one of the plurality of guide walls 142 constituting the other side guide wall group 145 is inclined with respect to the central axis line CL1 of the blowout passage 122 so as to be closer to the other side in the vehicle width direction DR3 the more toward the vehicle upper side. Specifically, when the air flow deflection door 14 is in the second operation state, among the plurality of guide walls 142 of the other side guide wall group 145, the closer a particular guide wall 142 is arranged toward the other side in the vehicle width direction DR3, the more the vehicle upper side of that guide wall 142 is inclined toward the other side in the vehicle width direction DR3 with respect to the central axis CL1.

In other words, in both the one side guide wall group 144 and the other side guide wall group 145, when the air flow deflection door 14 is in the second operation state, the closer a guide wall 142 is positioned toward the center position of the plate door portion 141 in the vehicle width direction DR3, the smaller the angle formed by that guide wall 142 with respect to the central axis line CL1. For this reason, in each of the one side guide wall group 144 and the other side guide wall group 145, the guide walls 142 arranged closest to the ends of the plate door portion 141 in the vehicle width direction DR3 have the largest inclination with respect to the central axis line CL1.

Due to the orientations of the guide walls 142 in this manner, when the air flow deflection door 14 is in the second operation state, the plurality of guide walls 142 of the one side guide wall group 144 are arranged guide the blowout air such that the blowout air is diffused from the blowout port 121 toward the one side in the vehicle width direction DR3. At the same time, the plurality of guide walls 142 of the other side guide wall group 145 guide the blowout air such that the blowout air is diffused from the blowout port 121 toward the other side in the vehicle width direction DR3.

As described above, according to the present embodiment, as shown in FIGS. 2 to 4, by switching the air flow deflection door 14 between the first operation state and the second operation state, the direction of the blowout air blown out from the blowout port 121 Is adjusted along the vehicle front-rear direction DR2. Then, when the air flow deflection door 14 is in the first operation state, the guide walls 142 of the air flow deflection door 14 are arranged so as to protrude from the plate door portion 141 toward the upper side of the vehicle so as to be positioned on the blowout air flow downstream side of the plate door portion 141. That is, the guide walls 142 are arranged so as not to protrude out of the stagnation zone Ast, and tend to not to interfere with the flow of the blowout air toward the blowout port 121. For this reason, during the face mode, it is possible to avoid a decrease in air volume caused by ventilation resistance from the guide walls 142.

Conversely, when the air flow deflection door 14 is in the second operation state, the guide walls 142 guide the air toward the blowout port 121 and regulate the direction of the guided air flow with respect to the vehicle width direction DR3. Accordingly, due to the operation of the air flow deflection door 14, it is possible to change the direction of the blowout air in the vehicle width direction DR3 in conjunction with changing the direction of the blowout air in the vehicle front-rear direction DR2. Thus, it is possible to change the direction of the blowout air in the vehicle front-rear direction DR2 and also in the vehicle width direction DR3.

Furthermore, according to the air discharge device 10 of the present embodiment, since a member corresponding to the left-right direction adjusting doors of the air discharge device of Patent Document 1 is unnecessary, it is possible to limiting an increase in the number of components of the air discharge device 10. Compared to the air discharge device of Patent Document 1, it is possible to reduce the cost of the air discharge device 10 by reducing the number of components of the air discharge device 10. Also, since there are no left-right direction adjusting doors, it is easy to reduce the physical size of the air discharge device 10.

Further, according to the present embodiment, as shown in FIGS. 4 and 6, when the air flow deflection door 14 is in the second operation state, any one of the plurality of guide walls 142 constituting the one side guide wall group 144 is inclined with respect to the central axis line CL1 (see FIG. 2) so as to be closer to the one side in the vehicle width direction DR3 the more toward the vehicle upper side. Further, when the air flow deflection door 14 is in the second operation state, any one of the plurality of guide walls 142 constituting the other side guide wall group 145 is inclined with respect to the central axis line CL1 so as to be closer to the other side in the vehicle width direction DR3 the more toward the vehicle upper side. Due to this, when the air flow deflection door 14 is in the second operation state, it is possible to blow out the blowout air while diffusing the blowout air over a wide range from one side to the other side in the vehicle width direction DR3 with respect to the front of the blowout port 121.

Further, according to the present embodiment, as shown in FIGS. 4 and 6, when the air flow deflection door 14 is in the second operation state, among the plurality of guide walls 142 of the one side guide wall group 144, the closer a particular guide wall 142 is arranged toward the one side in the vehicle width direction DR3, the more the vehicle upper side of that guide wall 142 is inclined toward the one side in the vehicle width direction DR3 with respect to the central axis CL1 of the blowout passage 122. Thus, when the air flow deflection door 14 is in the second operation state, it is possible to blow out the blowout air from the front face of the blowout port 121 while evenly diffusing the blowout air toward the one side in the vehicle width direction DR3.

Further, according to the present embodiment, as shown in FIGS. 4 and 6, when the air flow deflection door 14 is in the second operation state, among the plurality of guide walls 142 of the other side guide wall group 145, the closer a particular guide wall 142 is arranged toward the other side in the vehicle width direction DR3, the more the vehicle upper side of that guide wall 142 is inclined toward the other side in the vehicle width direction DR3 with respect to the central axis CL1 of the blowout passage 122. Thus, when the air flow deflection door 14 is in the second operation state, it is possible to blow out the blowout air from the front face of the blowout port 121 while evenly diffusing the blowout air toward the other side in the vehicle width direction DR3.

Further, according to the present embodiment, as shown in FIGS. 3 and 6, the one side guide wall group 144 is formed by the plurality of guide walls 142 arranged on one side in the vehicle width direction DR3 (that is, on the right side of the vehicle), with the central portion of the plate door portion 141 as the boundary. Further, the other side guide wall group 145 is formed by the plurality of guide walls 142 arranged on the other side in the vehicle width direction DR3 (that is, on the left side of the vehicle), with the central portion of the plate door portion 141 as the boundary. As a result, when the air flow deflection door 14 is in the second operation state, the blowout air can be blown out and widely diffused along the vehicle width direction DR3 centered around the blowout port 121.

Further, according to the present embodiment, as shown in FIGS. 2 to 4, the air flow deflection door 14 rotates about the rotation axis CL3, which extends along the vehicle width direction DR3, to switch between the first operation state and the second operation state. In addition, each of the guide walls 142 has the end edge 142a that protrudes from the plate door portion 141, the end edges 142a being curved in a convex shape. Therefore, it is easy to dispose the guide walls 142 so that the guide walls 142 tend to not interfere with the air flow to the blowout port 121 when the air flow deflection door 14 is in the first operation state.

Further, according to the present embodiment, as shown in FIGS. 2 and 4, when the air flow deflection door 14 is in the second operation state, the passage cross-sectional area of the front side passage 122b is greater than the passage cross-sectional area of the rear side passage 122a. In addition, when the air flow deflection door 14 is in the second operation state, the guide walls 142 are disposed so as to protrude into the front side passage 122b. As a result, when the air flow deflection door 14 is in the second operation state, the guide walls 142 guide the air in the front side passage 122b, which has a higher air flow rate among the rear side passage 122a and the front side passage 122b, towards the blowout port 121. For this reason, as compared with a configuration in which the guide walls 142 guide the air in the rear side passage 122a which has a lower air flow rate, it is possible to effectively adjust the direction of the blowout air with the guide walls 142 when the air flow deflection door 14 is in the second operation state.

Further, according to the present embodiment, as shown in FIGS. 3 and 5, each of the plurality of guide walls 142 protrudes from the guide base surface 141a along the normal direction DRg to the guide base surface 141a. Therefore, when the air flow deflection door 14 is manufactured as an integrally molded product by injection molding or the like, it is possible to form the air flow deflection door 14 in a shape that facilitates die cutting.

Here, an air discharge device 90 of a comparative example will be described as a comparison to the present embodiment. The air discharge device 90 of the comparative example is different from the air discharge device 10 of the present embodiment in that the air flow deflection door 14 does not have the guide walls 142. The air discharge device 90 of the comparative example is otherwise the same as the air discharge device 10 of the present embodiment in other respects.

According to the air discharge device 90 of the comparative example shown in FIG. 7, in the defroster mode, the blowout air is diffused to a certain extent in the vehicle width direction DR3 as indicated by the arrows FLe. However, since there are no guide walls 142, the blowout air cannot be proactively diffused in the vehicle width direction DR3. For example, regions Ang in the front window 71 where the blowout air is not sufficiently distributed may exist in the lower part of both ends of the front window 71 in the vehicle width direction DR3. In this case, in the region Ang where blowout air is insufficient, the window clearing effect of the air discharge device 90 in the defroster mode is insufficient.

On the other hand, according to the present embodiment, as shown in FIGS. 1, 3, and 4, the air flow deflection door 14 has the plurality of guide walls 142.

Further, the blowout port 121 is provided in the central portion of the width Wrm of the passenger compartment in the vehicle width direction DR3 within the upper surface 701 of the instrument panel 70 in the passenger compartment, and is disposed on the vehicle lower side with respect to the front window 71 of the vehicle. Accordingly, when the air flow deflection door 14 is in the second operation state, due to the effects of the guide walls 142, it is possible to spread out the blowout air to the front window 71 in a wide range as indicated by the arrows FLd.

As a result, for example, it is possible to obtain sufficient window clearing performance while avoiding interference from structures other than the air discharge device provided in the instrument panel 70 (for example, the HUD 76, the meter panel 781, the meter hood 782, and so on). In particular, it is possible to obtain sufficient window clearing performance even in the regions Ang (see FIG. 7) in the lower part of both ends in the vehicle width direction DR3. Accordingly, the air discharge device 10 of the present embodiment can be mounted on the vehicle together with the HUD 76, the meter panel 781, the meter hood 782, and the like.

### Second Embodiment

A second embodiment of the present disclosure is described next. The present embodiment will be explained primarily with respect to portions different from those of the first embodiment. In addition, explanations of the same or equivalent portions as those in the above embodiment will be omitted or simplified. This also applies to the embodiments described after the present embodiments.

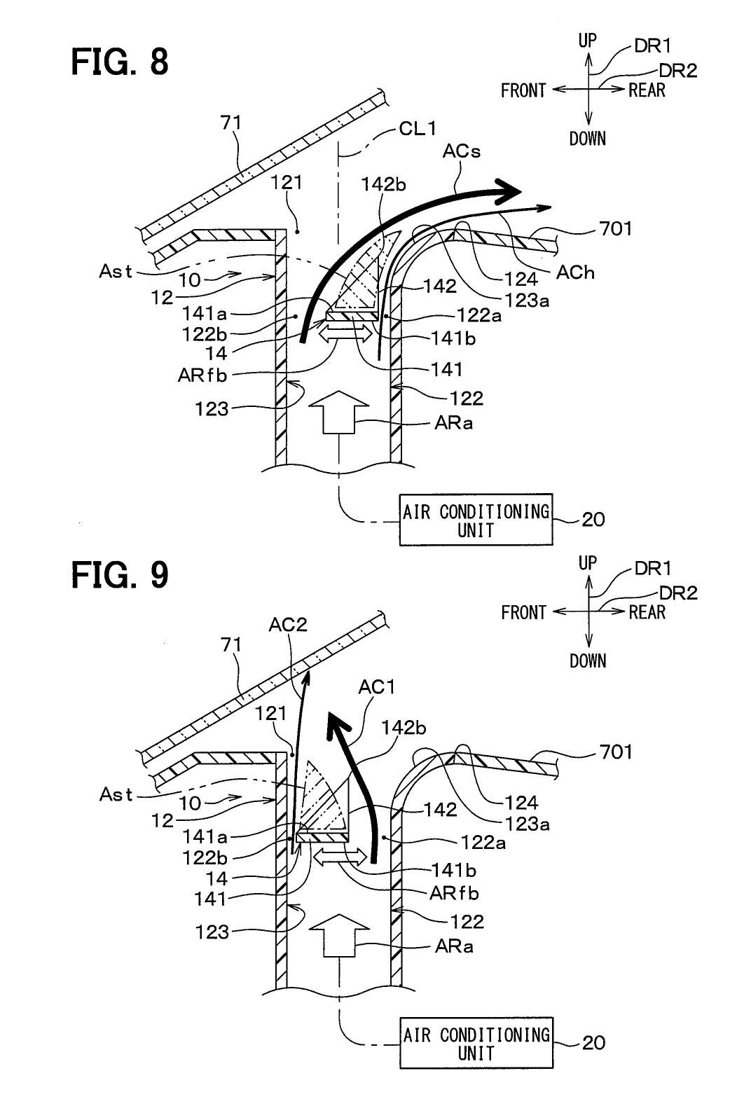

As shown in FIGS. 8 and 9, in the present embodiment, the air flow deflection door 14 slides along the vehicle front-rear direction DR2 as indicated by the arrow ARfb. Further, the plurality of guide walls 142 of the air flow deflection door 14 have a substantially triangular shape. In this respect, this embodiment is different from the first embodiment.

Specifically, the plate door portion 141 of the air flow deflection door 14 of the present embodiment has, for example, a rectangular flat plate shape with a thickness direction that coincides with the vehicle up-down direction DR1. Further, similar to the first embodiment, the air flow deflection door 14 of the present embodiment is selectively switched between the first operation state and the second operation state according to the blowout mode of the air discharge device 10.

In other words, as shown in FIG. 8, when the air flow deflection door 14 enters the first operation state, the flow of the air flowing through the rear side passage 122a is throttled by the plate door portion 141 as compared to the air prior to flowing into the rear side passage 122a. Accordingly, the flow of the air is made to follow the passage guide surface 123a.

Conversely, when the air flow deflection door 14 is in the second operation state, as shown in FIG. 9, the air flow deflection door 14 reduces the throttling of the flow of air flowing through the rear side passage 122a as compared with the case when the air flow deflection door 14 is in the first operation state. For example, in the second operation state, the air flow deflection door 14 makes the passage cross-sectional area of the rear side passage 122a larger than the passage cross-sectional area of the front side passage 122b.

Further, as shown in FIGS. 8 and 9, each of the substantially triangular shaped guide walls 142 has a top portion 142b at the vehicle upper side end. The top portion 142b of the plate door portion 141 is biased toward the vehicle rear side within the width of the plate door portion 141 in the vehicle front-rear direction DR2. The guide walls 142 of the present embodiment are the same as the guide walls 142 of the first embodiment except for their shapes.

Specifically, in the same manner as the first embodiment, when the air flow deflection door 14 is in the first operation state, the plurality of guide walls 142 are disposed so as to protrude from the plate door portion 141 toward the vehicle upper side. However, since the air flow deflection door 14 slides along the vehicle front-rear direction DR2 without rotating, even when the air flow deflection door 14 is in the second operation state, the plurality of guide walls 142 are disposed so as to protrude from the plate door portion 141 toward the vehicle upper side.

Further, since the air flow deflection door 14 slides and moves along the vehicle front-rear direction DR2 without rotating, the stagnation zone Ast is formed not only when the air flow deflection door 14 is in the first operation state, but also when the air flow deflection door 14 is in the second operation state. However, as shown in FIG. 9, when the air flow deflection door 14 is in the second operation state, due to the direction of the air flow AC1 in the rear side passage 122a and the direction of the air flow AC2 in the front side passage 122b, the stagnation region Ast is deformed so as to be biased toward the front side of the vehicle. As described above, the top portions 142b of the guide walls 142 are positioned so as to be biased toward the vehicle rear side within the width of the plate door portion 141 in the vehicle longitudinal direction DR2. Therefore, when the air flow deflection door 14 is in the second operation state, the guide walls 142 protrude out of the stagnation zone Ast toward the vehicle rear side. As a result, the guide walls 142 guide the blowout air toward the blowout port 121. Specifically, the guide walls 142 guide the air flow AC1 in the rear side passage 122a. Further, the guide walls 142 regulate the direction of the guided blowout air flow along the vehicle width direction DR3.

In the present embodiment, effects similar to those of the first embodiment described above can be obtained in the same manner as in the first embodiment.

### COMPARATIVE EXAMPLE

Next, an air discharge device of another comparative example (not illustrated) will be described in order to more easily appreciate the advantageous aspects of the embodiments described in the present disclosure.

An air discharge device of this comparative example includes a duct connected to a blowout port, an air flow deflection door disposed inside the duct, and a plurality of left-right direction adjusting doors which adjust the air blowing direction from the blowout port. The air flow deflection door is operated so as to generate an air flow along a guide surface provided on a vehicle rear side of the duct. Further, the plurality of left-right direction adjusting doors adjust the direction of the blowout air blown out from the blowout port along the left-right direction of the vehicle by adjusting the direction of the air flow flowing inside the duct along the left-right direction of the vehicle. The plurality of left-right direction adjusting doors are arranged on an air flow upstream side with respect to the air flow deflection door.

In the air discharge device of this comparative example, since the left-right direction adjusting doors are provided, it is possible to adjust the direction of the blown air along the left-right direction of the vehicle. Therefore, for example, the direction of the blown air along the left-right direction of the vehicle can be changed according to the adjustment of the left-right direction adjustment doors in accordance with the direction of the blown air which is changed along the vehicle front-rear direction by the air flow deflection door. However, in the comparative example, providing the left-right direction adjusting doors in addition to the air flow deflection door leads to an increase in the number of components of the air discharge device.

In contrast, according to the exemplary embodiments above and modified examples below described in the present disclosure, it is possible to provide an air discharge device capable of changing the direction of the blown air in one direction and also in another direction intersecting the one direction, while limiting an increase in the number of components. For example, as compared to this comparative example described above, the left-right direction adjusting doors are not necessary, and so it is possible to limit an increase in the number of components of the air discharge device.

### Other Embodiments

(1) In each of the above described embodiments, the air flow deflection door 14 has a large number of guide walls 142, but the number of the guide walls 142 is not limiting. For example, as an alternative, the number of the guide walls 142 may be one.

(2) In the above described first embodiment, the plurality of guide walls 142 included in each of the one side guide wall group 144 and the other side guide wall group 145 are arranged such that when the air flow deflection door 14 is in the second operation state, the plurality of guide walls 142 are inclined as shown in FIG. 6. However, various other orientations for the guide walls 142 are contemplated. For example, the guide walls 142 shown in FIGS. 10 to 13 to be described later are contemplated.

FIG. 10 shows a first modified example of the first embodiment. In the first modified example, when the air flow deflection door 14 is in the second operation state, all of the plurality of guide walls 142 constituting the one side guide wall group 144 are inclined with respect to the central axis line CL1 (see FIG. 2) of the blowout passage 122 so as to be closer to the one side in the vehicle width direction DR3 the more toward the vehicle upper side. Further, when the air flow deflection door 14 is in the second operation state, all of the plurality of guide walls 142 constituting the other side guide wall group 145 are inclined with respect to the central axis line CL1 of the blowout passage 122 so as to be closer to the other side in the vehicle width direction DR3 the more toward the vehicle upper side.

Furthermore, in the first modified example of FIG. 10, all the guide walls 142 of the one side guide wall group 144 are parallel to each other. Similarly, all the guide walls 142 of the other side guide wall group 145 are parallel to each other. Further, FIG. 11 shows a second modified example of the first embodiment. In the second modified example, when the air flow deflection door 14 is in the second operation state, among the one side guide wall group 144 and the other side guide wall group 145, the guide walls 142 arranged closest to the center of the width of the plate door portion 141 in the vehicle width direction are oriented to extend along the center axis CL1. At the same time, aside from the guide walls 142 of the one side guide wall group 144 closest to the center, the remaining guide walls 142 are inclined with respect to the central axis line CL1 of the blowout passage 122 so as to be closer to the one side in the vehicle width direction DR3 the more toward the vehicle upper side. Further, aside from the guide walls 142 of the other side guide wall group 145 closest to the center, the remaining guide walls 142 are inclined with respect to the central axis line CL1 of the blowout passage 122 so as to be closer to the other side in the vehicle width direction DR3 the more toward the vehicle upper side.

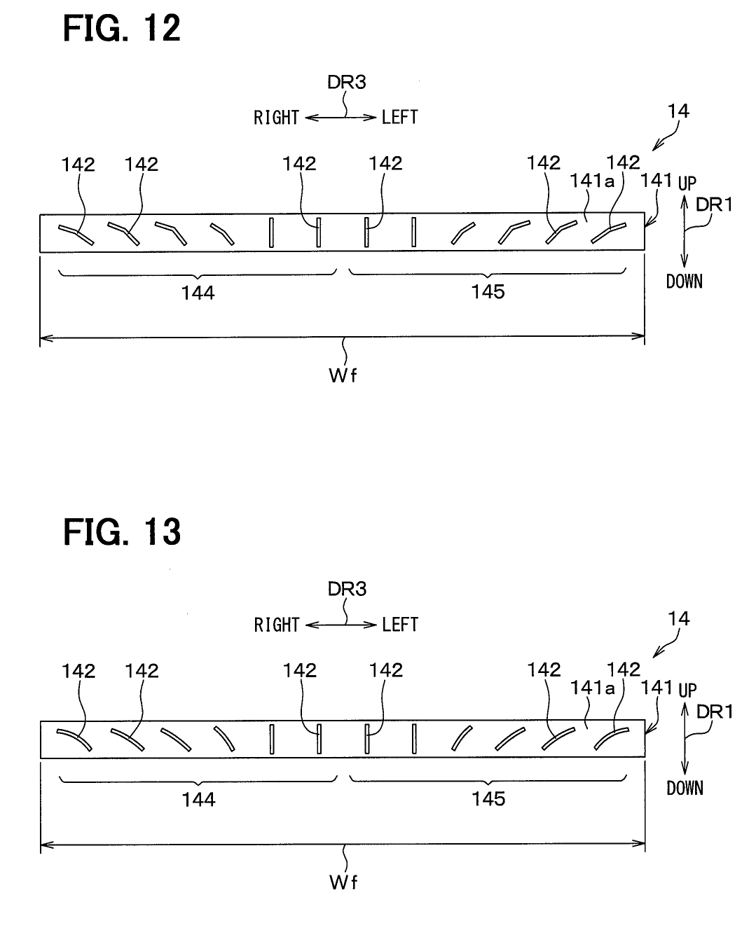

Further, FIG. 12 shows a third modified example of the first embodiment. In the third modified example, the inclination distribution of the guide walls 142 included in each of the one side guide wall group 144 and the other side guide wall group 145 is the same as that in the second modified example. However, in the second modification of FIG. 11, the respective guide walls 142 are formed so as to extend linearly between one end on one side and an other end on an other side of the direction along which the guide base surface 141a extends. In contrast, in the third modified example of FIG. 12, the guide walls 142 which are inclined with respect to the center axis CL1 when the air flow deflection door 14 is in the second operation state are formed with a bend between one end on one side to the other end on the other side of those guide walls 142. Further, when the air flow deflection door 14 is in the second operation state, each of the bent guide walls 142 is bent such that the vehicle upper side thereof is more inclined with respect to the center axis CL1 than the vehicle lower side thereof.

Further, FIG. 13 shows a fourth modified example of the first embodiment. In the fourth modified example, the inclination distribution of the guide walls 142 included in each of the one side guide wall group 144 and the other side guide wall group 145 is the same as that in the second modified example. However, in the fourth modified example of FIG. 13, the guide walls 142 which are inclined with respect to the center axis CL1 when the air flow deflection door 14 is in the second operation state are formed with a curve between the one end on the one side and the other end on the other side of the direction along the guide base surface 141a. Further, when the air flow deflection door 14 is in the second operation state, each of the curved guide walls 142 is curved so that the closer toward the vehicle upper side thereof, the more that guide wall 142 is inclined with respect to the center axis CL1.

In any of the air flow deflection doors 14 shown in FIG. 6 and FIGS. 10 to 13, when the air flow deflection door 14 is in the second operation state, at least one of the plurality of guide walls 142 is inclined with respect to the center axis CL1 (see FIG. 2) of the blowout passage 122 such that, the further toward the vehicle upper side, the further away that at least one guide wall 142 is from the center of the width Wf of the plate door portion 141 in the vehicle width direction DR3. Therefore, when the air flow deflection door 14 is in the second operation state, it is possible to blow out the blowout air from the blowout port 121 such that the blowout air diffuses along the vehicle width direction DR3. Further, when the air flow deflection door 14 is in the second operation state, the inclination angle of each of the guide walls 142 with respect to the central axis CL1 may be defined as an angle formed between the central axis CL1 and a line connecting the one end of the guide wall 142 on the vehicle upper side and the other end of the guide wall 142 on the vehicle lower side.

(3) In each of the above described embodiments, the blowout port 121 is provided on the upper surface 701 of the instrument panel 70, but the location at which the blowout port 121 is provided is not limited to this.

(4) In each of the above described embodiments, the blowout port 121 opens facing upward in the vehicle up-down direction DR1. However, it is also contemplated that the blowout port 121 may open facing in a direction other than the upper side.

(5) In the first embodiment described above, as shown in FIG. 4, when the air flow deflection door 14 is in the second operation state, the guide base surface 141a of the plate door portion 141 faces toward the vehicle front side. However, this is only an example. As another example, when the air flow deflection door 14 is in the second operation state, the guide base surface 141a of the plate door portion 141 may face toward the vehicle rear side instead.

The above described embodiments are not intended to be exhaustive or to limit the present disclosure. The present disclosure is intended to cover various modification and equivalent arrangements. Individual elements or features of a particular embodiment are not necessarily essential unless it is specifically stated that the elements or the features are essential in the foregoing description, or unless the elements or the features are obviously essential in principle.

A quantity, a value, an amount, a range, or the like, if specified in the above described example embodiments, is not necessarily limited to the specific value, amount, range, or the like unless it is specifically stated that the value, amount, range, or the like is necessarily the specific value, amount, range, or the like, or unless the value, amount, range, or the like is obviously necessary to be the specific value, amount, range, or the like in principle. Furthermore, a material, a shape, a positional relationship, or the like, if specified in the above described example embodiments, is not necessarily limited to the specific material, shape, positional relationship, or the like unless it is specifically stated that the material, shape, positional relationship, or the like is necessarily the specific material, shape, positional relationship, or the like, or unless the material, shape, positional relationship, or the like is obviously necessary to be the specific material, shape, positional relationship, or the like in principle.

(Conclusion)

According to a first aspect illustrated by a part or all of the above described embodiments, the guide wall is arranged so as to, when the air flow manipulation member is in the first operation state, protrude from the main body portion toward the one side in the first direction. Further, when the air flow manipulation member is in the second operation state, the guide wall guides air toward the blowout port while regulating a direction of the flow of the guided air along the third direction.

Further, according to a second aspect, when the air flow manipulation member is in the second operation state, among the plurality of guide walls included in the air flow manipulation member, at least one of the guide walls is inclined with respect to the axis line such that the further toward the one side in the first direction, the further away the at least one of the guide walls is from a center of a width of the main body portion in the third direction. Therefore, when the air flow manipulation member is in the second operation state, it is possible to blow out the blowout air from the blowout port such that the blowout air diffuses along the third direction.

Further, according to a third aspect, when the air flow manipulation member is in the second operation state, any or all of the plurality of guide walls included in the one side guide wall group is inclined with respect to the axis line so as to be positioned closer toward the one side in the third direction the further toward the one side in the first direction. Further, when the air flow manipulation member is in the second operation state, any or all of the plurality of guide walls included in the other side guide wall group is inclined with respect to the axis line so as to be positioned closer toward the other side in the third direction the further toward the one side in the first direction. Due to this, when the air flow manipulation member is in the second operation state, it is possible to blow out the blowout air while diffusing the blowout air from one side to the other side in the third direction with respect to the front of the blowout port.

Further, according to a fourth aspect, the plurality of guide walls of the one side guide wall group are arranged such that, the closer a particular guide wall is disposed toward the one side in the third direction, the more the one side of that particular guide wall in the first direction is inclined toward the one side in the third direction with respect to the axis line. Due to this, when the air flow manipulation member is in the second operation state, it is possible to blow out the blowout air from the front face of the blowout port while evenly diffusing the blowout air toward the one side in the third direction.

Further, according to a fifth aspect, the plurality of guide walls of the other side guide wall group are arranged such that, the closer a particular guide wall is disposed toward the other side in the third direction, the more the one side of that particular guide wall in the first direction is inclined toward the other side in the third direction with respect to the axis line. Due to this, when the air flow manipulation member is in the second operation state, it is possible to blow out the blowout air from the front face of the blowout port while evenly diffusing the blowout air toward the other side in the third direction.

Further, according to a sixth aspect, the plurality of guide walls of the one side guide wall group are disposed toward the one side in the third direction with a central portion of the main body portion as a boundary. In addition, the plurality of guide walls of the other side guide wall group are disposed toward the other side in the third direction with the central portion of the main body portion as the boundary. Due to this, when the air flow manipulation member is in the second operation state, the blowout air can be blown out and widely diffused along the third direction centered around the blowout port.

Further, according to a seventh aspect, the air flow manipulation member switches between the first operation state and the second operation state by rotating about a rotation axis along the third direction. Further, the guide wall has a convexly curved end edge protruding from the main body portion. Therefore, it is easy to dispose the guide wall so that the guide wall tends to not interfere with the air flow to the blowout port when the air flow manipulation member is in the first operation state.

Further, according to an eighth aspect, when the air flow manipulation member is in the second operation state, a passage cross-sectional are of the other side passage is greater than a passage cross-sectional area of the one side passage. In addition, when the air flow manipulation member is in the second operation state, the guide wall is disposed so as to protrude out into other side passage. Due to this, when the air flow manipulation member is in the second operation state, the guide wall guides the air in the other side passage, which has a higher air flow rate among the one side passage and the other side passage, towards the blowout port. For this reason, as compared with a configuration in which the guide wall guides the air in the one side passage which has a lower air flow rate, it is possible to effectively adjust the direction of the blowout air with the guide wall when the air flow manipulation member is in the second operation state.

Further, according to a ninth aspect, the guide wall of the air flow manipulation member protrudes from the guide base surface along a normal direction to the guide base surface. Therefore, when the air flow manipulation member is manufactured as an integrally molded product by injection molding or the like, it is possible to form the air flow manipulation member in a shape that facilitates die cutting.

Further, according to a tenth aspect, the blowout port is provided in a central portion of a width of the passenger compartment in the vehicle left-right direction within an upper surface of an instrument panel in the passenger compartment, and is disposed on a vehicle lower side with respect to a front window of a vehicle. Accordingly, when the air flow manipulation member is in the second operation state, due to the effects of the guide walls, it is possible to spread out the blowout air to the front window in a wide range. As a result, for example, it is possible to obtain sufficient window clearing performance while avoiding interference from structures other than the air discharge device provided in the instrument panel.

1. An air discharge device that blows out air into a passenger compartment, comprising:
a blowout portion including a passage guide surface, the blowout portion forming a blowout port that opens toward one side in a first direction along an axis line and a blowout passage connected to the blowout port that guides air toward the blowout port, the blowout port being configured to blow out air into the passenger compartment; and
an air flow manipulation member disposed in the blowout passage, the air flow manipulation member including a guide wall and a main body portion, wherein
the passage guide surface is positioned on one side of the blowout passage in a second direction that intersects the first direction to face the blowout passage, the passage guide surface extending from the one side in the first direction toward an other side opposite to the one side in the first direction while bending toward the one side in the second direction,
the air flow manipulation member
forms one side passage as a part of the blowout passage, the one side passage being positioned toward the one side in the second direction with respect to the main body portion, and
switches between a first operation state that throttles an air flow flowing in the one side passage with the main body portion as compared to the air prior to entering the one side passage to cause the air flow to flow along the passage guide surface, and a second operation state that reduces the throttling of the air flow flowing in the one side passage as compared with the first operation state, and
the guide wall
is arranged so as to, when the air flow manipulation member is in the first operation state, protrude from the main body portion toward the one side in the first direction, and
when the air flow manipulation member is in the second operation state, guides air toward the blowout port while regulating a direction of the flow of the guided air along a third direction that intersects the first direction and the second direction.

2. The air discharge device of claim 1, wherein
the air flow manipulation member includes a plurality of the guide wall, and
when the air flow manipulation member is in the second operation state, at least one of the guide walls is inclined with respect to the axis line such that the further toward the one side in the first direction, the further away the at least one of the guide walls is from a center of a width of the main body portion in the third direction.

3. The air discharge device of claim 1, wherein
the air flow manipulation member includes one side guide wall group having a plurality of the guide wall and an other side guide wall group having a plurality of the guide wall,
the one side guide wall group is disposed toward one side in the third direction with respect to the other side guide wall group, and
when the air flow manipulation member is in the second operation state, any or all of the plurality of guide walls included in the one side guide wall group is inclined with respect to the axis line so as to be positioned closer toward the one side in the third direction the further toward the one side in the first direction, and any or all of the plurality of guide walls included in the other side guide wall group is inclined with respect to the axis line so as to be positioned closer toward an other side opposite to the one side in the third direction the further toward the one side in the first direction.

4. The air discharge device of claim 3, wherein
the plurality of guide walls of the one side guide wall group are arranged such that, the closer a particular guide wall is disposed toward the one side in the third direction, the more the one side of that particular guide wall in the first direction is inclined toward the one side in the third direction with respect to the axis line.

5. The air discharge device of claim 3, wherein
the plurality of guide walls of the other side guide wall group are arranged such that, the closer a particular guide wall is disposed toward the other side in the third direction, the more the one side of that particular guide wall in the first direction is inclined toward the other side in the third direction with respect to the axis line.

6. The air discharge device of claim 3, wherein
the plurality of guide walls of the one side guide wall group are disposed toward the one side in the third direction with a central portion of the main body portion as a boundary, and
the plurality of guide walls of the other side guide wall group are disposed toward the other side in the third direction with the central portion of the main body portion as the boundary.

7. The air discharge device of claim 1, wherein
the air flow manipulation member switches between the first operation state and the second operation state by rotating about a rotation axis along the third direction, and
the guide wall has a convexly curved end edge protruding from the main body portion.

8. The air discharge device of claim 1, wherein
the air flow manipulation member forms an other side passage as a part of the blowout passage, the other side passage being positioned toward an other side opposite to the one side in the second direction with respect to the main body portion, and
when the air flow manipulation member is in the second operation state, a passage cross-sectional are of the other side passage is greater than a passage cross-sectional area of the one side passage, and the guide wall is disposed so as to protrude out into the other side passage.

9. The air discharge device of claim 1, wherein
the main body portion of the air flow manipulation member includes a guide base surface, and
the guide wall protrudes from the guide base surface along a normal direction to the guide base surface.

10. The air discharge device according to claim 1, wherein
the one side in the first direction is a vehicle upper side,
the one side in the second direction is a vehicle rear side,
the third direction is a vehicle left-right direction, and
the blowout port is provided in a central portion of a width of the passenger compartment in the vehicle left-right direction within an upper surface of an instrument panel in the passenger compartment, and is disposed on a vehicle lower side with respect to a front window of a vehicle.

11. An air discharge device that blows out air into a passenger compartment, comprising:
a blowout vent including
a passage guide surface,
a blowout port that opens toward one side in a first direction along an axis line of the blowout vent, the blowout port being configured to blow out air into the passenger compartment, and
a blowout passage connected to the blowout port that guides air toward the blowout port; and
an air flow door disposed in the blowout passage, the air flow door including a guide wall and a main body portion, wherein
the passage guide surface is forms one side of the blowout passage toward one side in a second direction that intersects the first direction, the passage guide surface extending from the one side in the first direction toward an other side opposite to the one side in the first direction while bending toward the one side in the second direction,
the air flow door is configured to
form one side passage as a part of the blowout passage, the one side passage being positioned toward the one side in the second direction with respect to the main body portion, and
switch between a first operation state in which the main body portion of the air flow door throttles an air flow flowing in the one side passage, and a second operation state that reduces the throttling of the air flow in the one side passage as compared with the first operation state, and
the guide wall is configured to
when the air flow door is in the first operation state, protrude from the main body portion toward the one side in the first direction, and
when the air flow door is in the second operation state, guide air toward the blowout port while regulating a direction of the flow of the guided air along a third direction that intersects the first direction and the second direction.
